(19) United States
(12) Patent Application Publication
(10) Pub. No.: US 2014/0347875 A1
(43) Pub. Date: Nov. 27, 2014

(54) LED CAR LIGHT WITH ENHANCED COOLING EFFECT

(71) Applicant: Yujing Technology Co., Ltd., New Taipei City (TW)

(72) Inventor: Cheng-Feng HUANG, New Taipei City (TW)

(73) Assignee: YUJING TECHNOLOGY CO., LTD., New Taipei City (TW)

(21) Appl. No.: 14/137,184

(22) Filed: Dec. 20, 2013

(30) Foreign Application Priority Data
May 24, 2013 (TW) 102209653

(51) Int. Cl. F21S 8/10

(52) U.S. Cl. CPC F21S 48/328
USPC 362/516

(57) ABSTRACT

An LED car light with enhanced cooling effect has a light shell, a fixing base, an LED light module and a reflecting cover. The outer wall extends from the edge of the rear wall and surrounds the rear wall, wherein the outer wall has a cooling section. The fixing base is mounted in the light shell and corresponding in position to the cooling section. The LED light module is mounted on the fixing base and has a base board, a first LED light source and a second LED light source, wherein the base board is in thermal contact with the cooling section of the light shell. The first LED light source and the second LED light source are mounted on the base board. A cooling efficiency of the LED car light is increased due to the thermal contact between the cooling section and the base board.

The current application claims a foreign priority to the patent application of Taiwan No. 102209653 filed on May 24, 2013.

### BACKGROUND OF THE INVENTION

1. Field of the Invention

The present invention relates to an LED car light and more particularly to an LED car light with enhanced cooling effect.

2. Description of Related Art

With reference to FIG. 7, a conventional LED car light has a light shell 91, a fixing base 92, a reflecting cover 93, a first LED light source 94, a second LED light source 95 and a lens 96.

The light shell 91 is made of metal and has multiple cooling fins 911 formed on an outer surface of the light shell 91. The fixing base 92 is mounted in the light shell 91 and has a fixing board 921 extending from the fixing base 92 and toward an axial direction of the light shell 91.

The reflecting cover 93 is mounted in the light shell 91 and on a side that has the fixing board 921 of the fixing base 92, wherein the reflecting cover 93 has a clap board 931 mounted in the reflecting cover 93 and divides a space in the reflecting cover 93 into a first reflex zone 932 and a second reflex zone 933. The clap board 931 has a slot formed through the clap board 931 and corresponding in shape to the fixing board 921 of the fixing base 92, wherein the fixing board 921 is inserted in the slot.

The first LED light source 94 and the second LED light source 95 are respectively mounted on two opposite sides of the fixing board 921, and are respectively mounted in the first reflex zone 932 and the second reflex zone 933. The lens 96 is mounted on the light shell 91 and faces the first reflex zone 932 and the second reflex zone 933.

Lights generated by the first LED light source 94 and the second LED light source 95 are respectively refracted by the first reflex zone 932 and the second reflex zone 933, and then are emitted from the lens 96.

The conventional LED car light is used as a near beam light or a high beam light, and when the first LED light source 94 and the second LED light source 95 generate lights for a long period of time, a large amount of heat is also generated. A cooling effect of the light shell 91 is not efficient enough to exhaust the heat immediately, and the fixing board 921 of the fixing base 92 has to endure the heat generated by the first LED light source 94 and the second LED light source 95 simultaneously. Thus, the first LED light source 94 and the second LED light source 95 may be damaged by the heat.

### SUMMARY OF THE INVENTION

The main objective of the invention is to provide an LED car light with enhanced cooling effect.

The LED car light with enhanced cooling effect comprises a light shell, a fixing base, an LED light module and a reflecting cover. The light shell has a rear wall, an outer wall and a front opening. The rear wall has an edge. The outer wall extends from the edge of the rear wall and surrounds the rear wall, wherein the outer wall has a cooling section and multiple cooling fins formed on the cooling section. The front opening is surrounded by the outer wall and is distal from the rear wall. The fixing base is mounted in the light shell and corresponding in position to the cooling section. The LED light module is mounted on the fixing base and has a base board, a first LED light source and a second LED light source, wherein the base board is in thermal contact with the cooling section of the light shell. The first LED light source and the second LED light source are mounted on the base board. The reflecting cover is mounted in the light shell and has a reflex surface facing the first LED light source and the second LED light source.

The baseboard of the LED light module is in thermal contact with the cooling section of the light shell, thus, heat generated by the first LED light source and the second LED light source can be conducted to the cooling fins of the cooling section. Therefore, cooling efficiency of the LED car light in accordance with the present invention is increased.

Furthermore, the first and the second LED light sources can be respectively used as two kinds of car light sources such as a high beam source and a near beam source. The first and the second LED light sources are both mounted on the baseboard and face the reflex surface of the reflecting cover to refract light, that is, the LED car light in accordance with the present invention has two car light modes which are capable of being alternately used as desired. In conclusion, the LED car light in accordance with the present invention can be used as two kinds of car lights to decrease a production cost of the car.

### BRIEF DESCRIPTION OF THE DRAWINGS

FIG. 1 is a perspective view of a preferred embodiment of an LED car light with enhanced cooling effect in accordance with the present invention;

FIG. 2 is an exploded view of the LED car light in FIG. 1;

FIG. 3 is another exploded view of the LED car light in FIG. 1;

FIG. 4 is an enlarged perspective view of an LED light module of the LED car light in FIG. 1;

FIG .5 is a side view in partial section of the LED car light in FIG. 1;

FIG. 6 is a rear view of the LED car light in FIG. 1; and

FIG. 7 is an exploded view of a conventional LED car light.

### DETAILED DESCRIPTION OF THE PREFERRED EMBODIMENTS

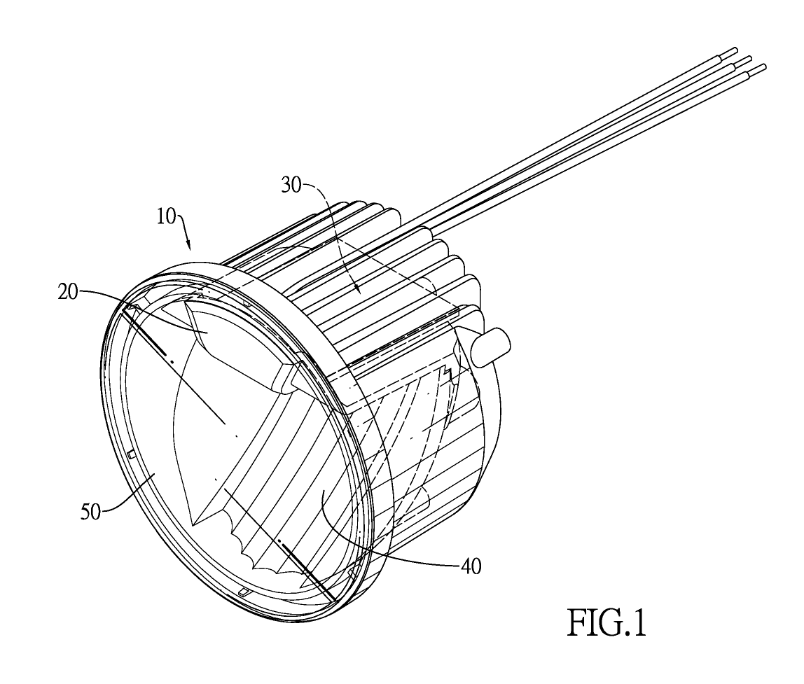

With reference to FIG. 1, a preferred embodiment of an LED car light with enhanced cooling effect in accordance with the present invention comprises a light shell 10, a fixing base 20, an LED light module 30 and a reflecting cover 40. In the preferred embodiment, the light shell 10 is made of aluminum-magnesium alloy and has a high heat dissipation rate, and the LED car light further comprises a lens 50.

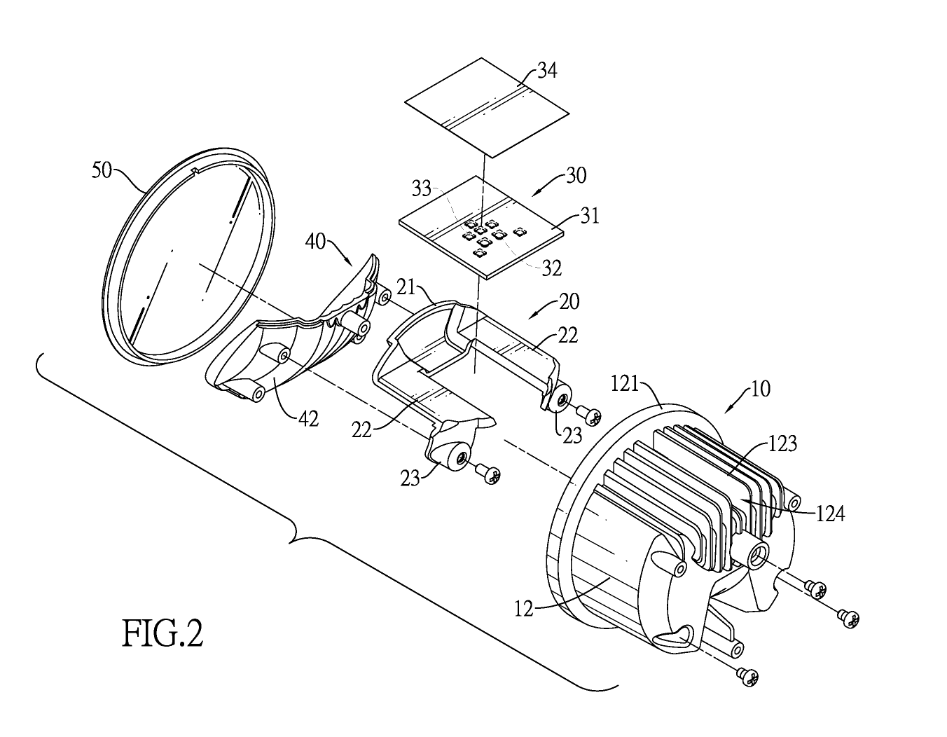

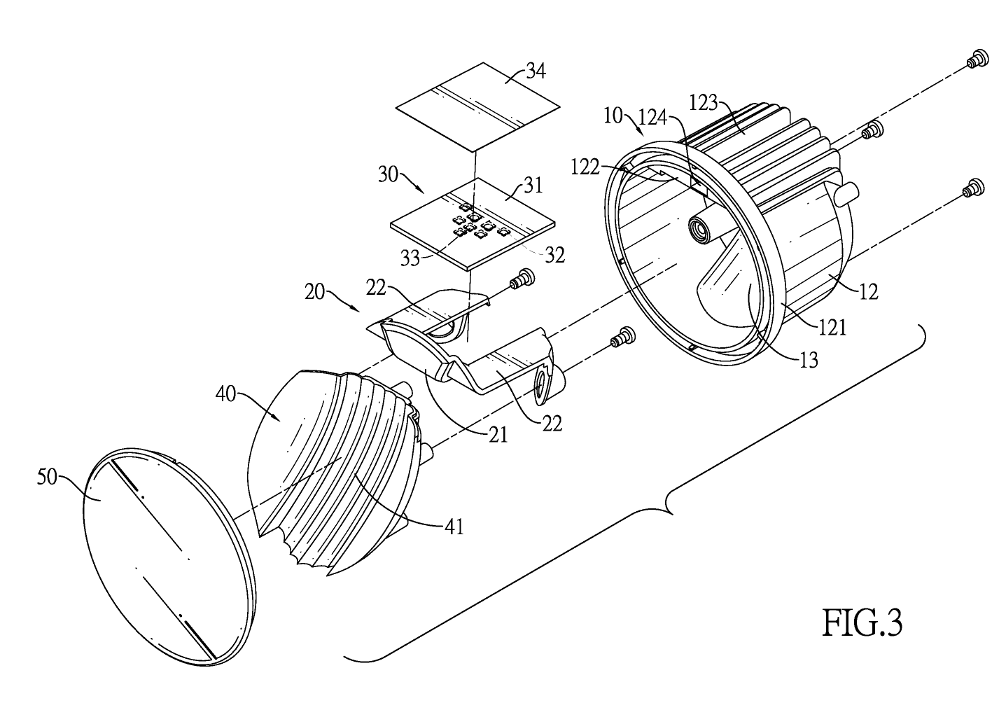

With reference to FIGS. 2 and 3, the light shell 10 is cup-shaped and has a rear wall 11, an outer wall 12 and a front opening 13. The rear wall 11 has an edge and multiple fixing holes formed through the rear wall 11. The outer wall 12 extends from the edge of the rear wall 11 and surrounds the rear wall 11. The outer wall 12 has an annular fixing flange 121, a cooling section 122, multiple cooling fins 123 and a line groove 124. The annular fixing flange 121 is formed on the outer wall 12 and surrounds the outer wall 12. The lens 50 is mounted in the annular fixing flange 121. The cooling section 122 is formed on a side of the outer wall 12. The multiple cooling fins 123 are formed at intervals and extend outward from the cooling section 122. The line groove 124 is formed through the light shell 10 and adapted for power line to mount through. The front opening 13 is surrounded by the outer wall 12 and is distal from the rear wall 11.

The fixing base 20 has a curved light shield 21, two parallel light shielding plates 22 and two connecting parts 23. The light shield 21 is convex toward the front opening 13 of the light shell 10 and has two ends. The two light shielding plates 22 are formed from the two ends of the light shield 21 respectively and extend toward the rear wall 11 horizontally. Each light shielding plate 22 has a free end. The two connecting parts 23 are formed form the two free ends of the two light shielding plates 22 respectively and extend downward. The reflecting cover 40 is connected to the two connecting parts 23. The fixing base 20 is mounted in the light shell 10 in an axial direction of the light shell 10.

The LED light module 30 is mounted on the fixing base 20 and is electrically connected to power lines mounted through the line groove 124 of the light shell 10. The LED light module 30 has a base board 31, a first LED light source 32 and a second LED light source 33. The base board 31 is mounted on the two light shielding plates 22 and contacts the cooling section 122 of the light shell 10. The first LED light source 32 and the second LED light source 33 are mounted on the base board 31 and vertically face the reflecting cover 40. In the preferred embodiment, the LED light module 30 further has a heat dissipating sheet 34 mounted between the base board 31 and the cooling section 122 to speed up a heat conduction between the base board 31 and the cooling section 122.

The reflecting cover 40 is curved and mounted in the light shell 10, and has a convex reflex surface 41 and a rear surface 42. The reflex surface 41 faces the first LED light source 32 and the second LED light source 33 to reflex lights generated by the first LED light source 32 and the second LED light source 33 out of the light shell 10. The rear surface 42 faces the rear wall 11, wherein multiple screws are mounted through the multiple fixing holes of the rear wall 11, the two connecting parts 23, and the rear surface 42 to fix the reflecting cover 40 in the light shell 10.

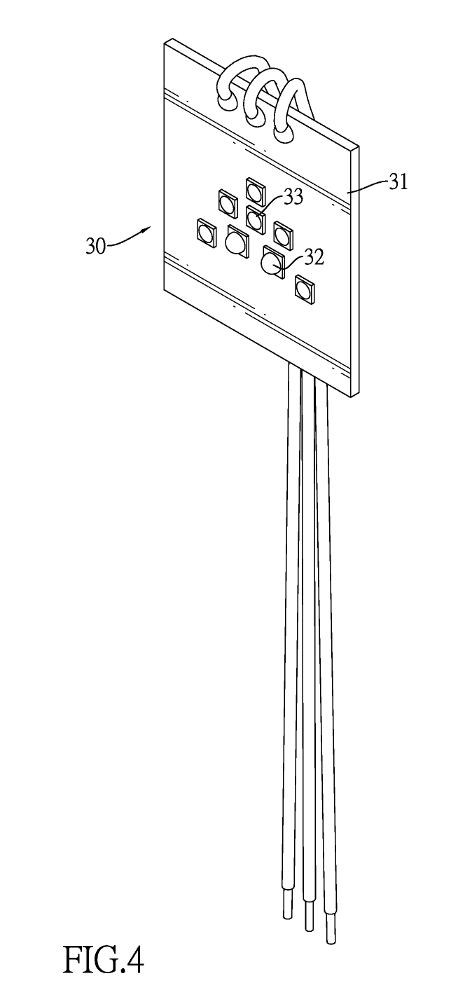

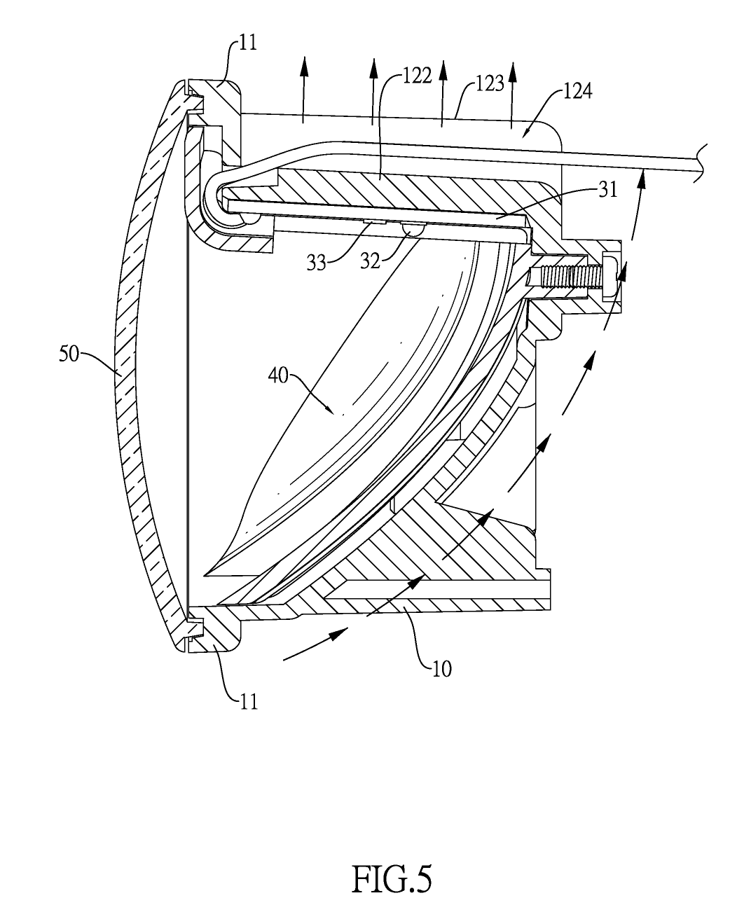

With reference to FIG. 4, in the preferred embodiment, the first LED light source 32 is a near beam module or a fog light module having multiple LED units and adapted for a vehicle. The second LED light source 33 is a high beam module or a daytime running module having multiple LED units and adapted for a vehicle. The base board 31 has multiple power contacts adapted for electrically connecting to power lines.

The base board 31 of the LED light module 30 is thermally contacted with the cooling section 122 of the light shell 10 directly, thus, heat generated by the base board 31 can be conducted to the multiple fins 123 of the cooling section 122 immediately. Therefore, a cooling efficiency is increased.

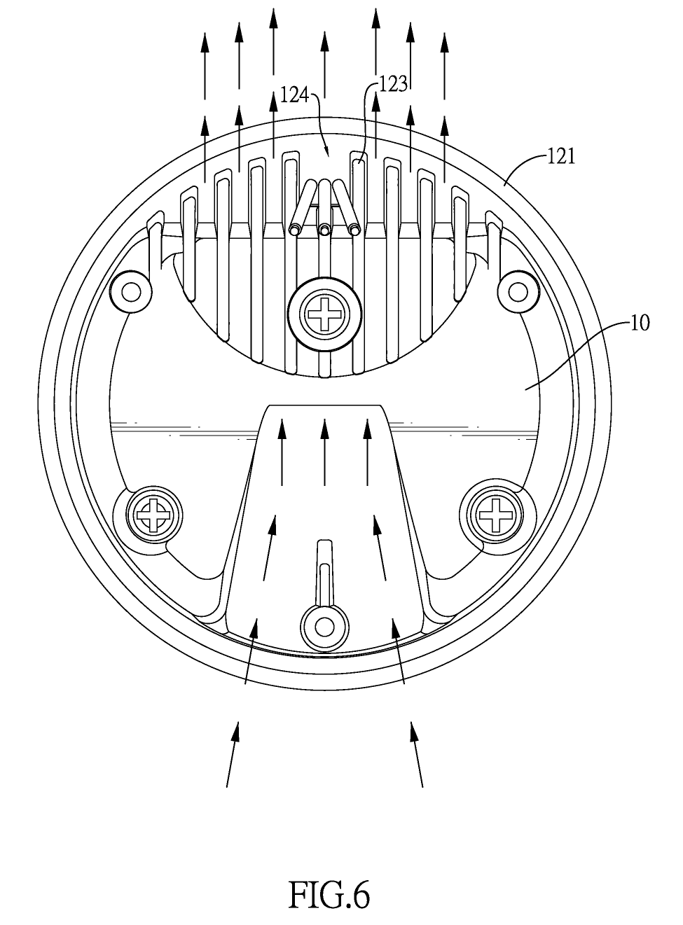

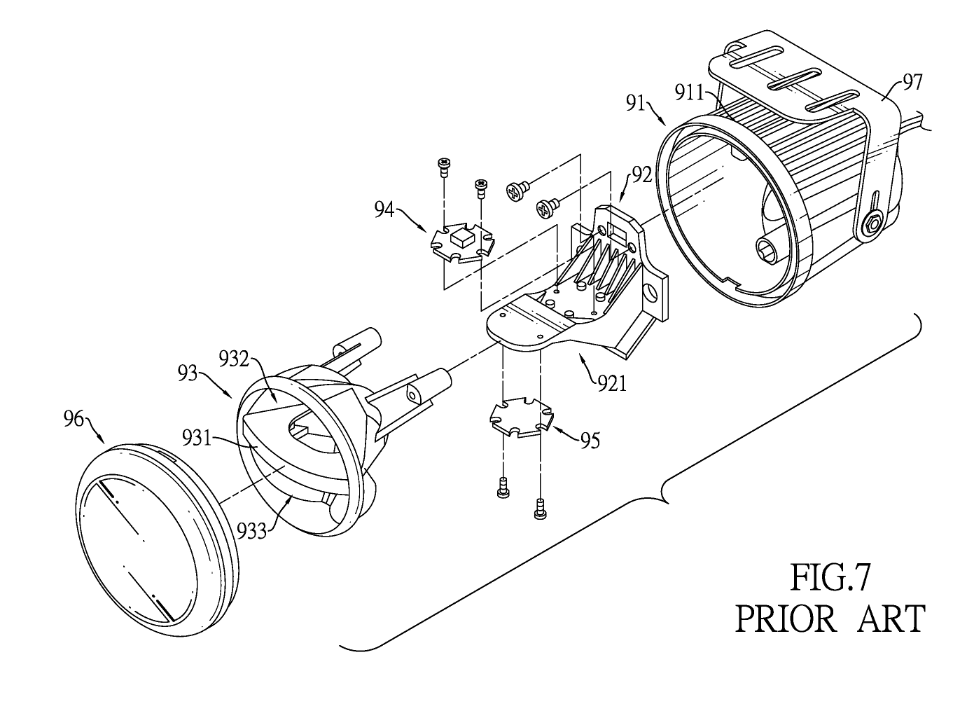

With reference to FIGS. 5 and 6, detail of a cooling effect of the preferred embodiment of the LED car light in accordance with the present invention will be disclosed in following paragraphs. Heat densities are different in the light shell 10, thus, there is a temperature difference in the light shell 10, wherein the heat flows to a cooler place in the light shell 10 causing a flow field which increases the cooling efficiency. When the LED light module 30 generates heat, hot air is drawn upward, wherein the base board 31 of the LED light module 30 is thermally contacted with the cooling section 122 of the light shell 10 directly for radiating the heat of the hot air by the multiple fins 123. Then, cold air is drawn upward. Therefore, a cooling efficiency is increased by the heat and convection between the hot and cold air.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. An LED car light with enhanced cooling effect comprising:
a light shell having
a rear wall having an edge;
an outer wall extending from the edge of the rear wall and surrounding the rear wall, wherein the outer wall has
a cooling section formed on a side of the outer wall; and
multiple cooling fins formed on the cooling section; and
a front opening surrounded by the outer wall and distal from the rear wall;
a fixing base mounted in the light shell and corresponding in position to the cooling section of the light shell;
an LED light module mounted on the fixing base and having
a base board thermally contacted with the cooling section of the light shell;
a first LED light source mounted on the base board; and
a second LED light source mounted on the base board; and
a reflecting cover mounted in the light shell and having;
a reflex surface facing the first LED light source and the second LED light source.

2. The LED car light as claimed in claim 1, wherein the light shell further comprises a line groove formed through the light shell.

3. The LED car light as claimed in claim 2, wherein the fixing base has:
a light shield having two ends; and
two light shielding plates formed from the two ends of the light shield respectively and extending toward the rear wall.

4. The LED car light as claimed in claim 3, wherein the first LED light source is a near beam module having multiple LED units; and
the second LED light source is a high beam module having multiple LED units.

5. The LED car light as claimed in claim 3, wherein the first LED light source is a fog light module having multiple LED units; and
the second LED light source is a daytime running light module having multiple LED units.

6. The LED car light as claimed in claim 4, wherein the LED light module further comprises a heat dissipating sheet mounted between the base board and the cooling section of the light shell.

7. The LED car light as claimed in claim 5, wherein the LED light module further comprises a heat dissipating sheet mounted between the base board and the cooling section of the light shell.

8. The LED car light as claimed in claim 1, wherein the light shell is cup-shaped and further comprises a lens mounted on the front opening of the light shell.

9. The LED car light as claimed in claim 2, wherein the light shell is cup-shaped and further comprises a lens mounted on the front opening of the light shell.

10. The LED car light as claimed in claim 3, wherein the light shell is cup-shaped and further comprises a lens mounted on the front opening of the light shell.

11. The LED car light as claimed in claim 4, wherein the light shell is cup-shaped and further comprises a lens mounted on the front opening of the light shell.

12. The LED car light as claimed in claim 5, wherein the light shell is cup-shaped and further comprises a lens mounted on the front opening of the light shell.

13. The LED car light as claimed in claim 6, wherein the light shell is cup-shaped and further comprises a lens mounted on the front opening of the light shell.

14. The LED car light as claimed in claim 7, wherein the light shell is cup-shaped and further comprises a lens mounted on the front opening of the light shell.

15. The LED car light as claimed in claim 3 further comprising multiple screws;
each light shielding plate of the fixing base having a free end;
two connecting parts extending down from the two free ends of the two light shielding plates respectively;
wherein the multiple screws are mounted through the rear wall of the light shell, the two connecting parts of the fixing base, and the reflecting cover.

16. The LED car light as claimed in claim 10 further comprising multiple screws;
each light shielding plate of the fixing base having a free end;
two connecting parts extending down from the two free ends of the two light shielding plates respectively;
wherein the multiple screws are mounted through the rear wall of the light shell, the two connecting parts of the fixing base, and the reflecting cover.
